(19) United States
(12) Patent Application Publication
(10) Pub. No.: US 2010/0097965 A1
(43) Pub. Date: Apr. 22, 2010

(54) DATA COMMUNICATION CONTROL

(76) Inventors: Tae Soo KWON, Hwaseong-si (KR); Kyung Hun JANG, Suwon-si (KR)

Correspondence Address: North Star Intellectual Property Law, PC, P.O. Box 34688, Washington DC, DC, 20043, US

(21) Appl. No.: 12/483,618

(22) Filed: Jun. 12, 2009

(30) Foreign Application Priority Data
Oct. 22, 2008 (KR) 10-2008-0103885

(51) Int. Cl. H04L 5/14; H04B 1/38

(52) U.S. Cl. 370/294; 455/561

(57) ABSTRACT

A femtocell base station apparatus may sense a wireless propagation environment around the femtocell base station apparatus to obtain wireless propagation environment information, transmit first control information including the wireless propagation environment information to at least one master base station adjacent to the femtocell base station apparatus, receive second control information from the at least one master base station, and control data communication performed between the femtocell base station apparatus and a mobile terminal based on the second control information.

### CROSS-REFERENCE TO RELATED APPLICATION(S)

This application claims the benefit under 35 U.S.C. §119(a) of a Korean Patent Application No. 10-2008-0103885, filed on Oct. 22, 2008, the entire disclosure of which is incorporated herein by reference for all purposes.

### BACKGROUND

1. Field

The following description relates to a data communication control, and more particularly, a femtocell base station apparatus and controlling method thereof.

2. Description of Related Art

Femtocell technology is a major technology used in the mobile communication market.

Originally, femtocell technology was developed to reduce an indoor shadow area of a mobile terminal or phone. However, femtocell technology may provide a variety of converging wired/wireless services using the Internet and the mobile phone.

A femtocell base station apparatus is a micromini mobile communication base station apparatus used indoors, such as in a house, office, and the like. Although performing similar functions as a wireless radio access network (RAN) repeater, the femtocell base station apparatus is a base station apparatus for accessing the mobile phone, as opposed to accessing the Internet.

A plurality of femtocell base station apparatuses may exist in a minimal cell coverage area of a single master base station. The master base station indicates all wired/wireless communication apparatuses that are able to control the femtocell base station apparatus. The master base station may be, for example, a macrocell base station apparatus, a microcell base station apparatus, or a picocell base station apparatus. The femtocell base station apparatus may perform data communication with the mobile terminal under control of the master base station.

The femtocell base station apparatus may be installed and managed according to requirements based on an on-demand method. However, since a wireless propagation environment around the femtocell varies over time, there is difficulty in planning an operation of the femtocell in advance. Therefore, in this instance, spectrum interference between a single femtocell base station apparatus and an adjacent femtocell base station apparatus or spectrum interference between the femtocell base station apparatus and the master base station may occur.

### SUMMARY

In one general aspect, a femtocell base station apparatus includes a sensing unit configured to sense a wireless propagation environment around the femtocell base station apparatus to obtain wireless propagation environment information, a transceiver configured to transmit first control information including the wireless propagation environment information to at least one master base station adjacent to the femtocell base station apparatus, and to receive second control information from the at least one master base station, and a controlling unit configured to control data communication performed between the transceiver and a mobile terminal based on the second control information.

The transceiver may transmit the first control information and receive the second control information using at least one of a wired communication network and a wireless communication network.

The wireless propagation environment information may include at least one of a channel gain of at least one frequency band and a signal-to-noise ratio (SNR) with respect to the at least one frequency band.

The first control information may further include at least one of a frequency bandwidth used when the data communication is performed, an amount of data to be communicated during the data communication, and a minimum cell coverage of the femtocell base station apparatus.

The second control information may include at least one of a frequency band available to the femtocell base station apparatus, maximum transmission power permitted in the frequency band, and a cell coverage of the femtocell base station apparatus.

The second control information may include wireless propagation environment information around at least one femtocell base station apparatus adjacent to the femtocell base station apparatus.

The transceiver may transmit the first control information using a time division duplex (TDD) frame signal including a transmission frame and reception frame, receive the second control information, and perform data communication with the mobile terminal.

The master base station and the transceiver may perform data communication with the mobile terminal using the same frequency band, and the controlling unit may transpose a location of the transmission frame and reception frame in the TDD frame signal to control the transceiver to transmit the first control information and receive the second control information.

The master base station and the transceiver may perform data communication with the mobile terminal using the same frequency band, and the controlling unit may shift a location of the transmission frame and reception frame in the TDD frame signal based on a predetermined value to control the transceiver to transmit the first control information and receive the second control information.

The master base station and the transceiver may perform data communication with the mobile terminal using different frequency bands from each other, and the transceiver may transmit the first control information and receives the second control information using a first frequency band in a frequency band used for data communication with the mobile terminal or a third frequency band excluding the frequency bands used for the data communication with the mobile terminal.

In another general aspect, a master base station controls a femtocell base station apparatus, the master base station including a receiving unit configured to receive first control information including wireless propagation environment information around the femtocell base station apparatus from the femtocell base station apparatus, a control information generating unit configured to generate second control information controlling an operation of the femtocell base station apparatus based on the first control information, and a transmitting unit configured to transmit the second control information to the femtocell base station apparatus.

The apparatus may further include a database storing at least one of the first control information and the second control information.

The second control information may include at least one of a frequency band available to the femtocell base station apparatus and maximum transmission power permitted in the frequency band.

In still another general aspect, a femtocell base station apparatus is controlled by sensing a wireless propagation environment around the femtocell base station apparatus to obtain wireless propagation environment information, transmitting first control information including the wireless propagation environment information to at least one master base station adjacent to the femtocell base station apparatus, receiving second control information from the at least one master base station, and controlling data communication performed between the femtocell base station apparatus and a mobile terminal based on the second control information.

The transmitting of the first control information may include transmitting the first control information via at least one of a wired communication network and a wireless communication network, and the receiving of the second control information may include receiving the second control information via at least one of the wired communication network and the wireless communication network.

The transmitting of the first control information may include transmitting the first control information using a Time Division Duplex (TDD) frame signal including a transmission frame and a reception frame, and the transmitting of the second control information may include transmitting the second control information using the TDD frame signal including the transmission frame and the reception frame.

The master base station and the femtocell base station may perform data communication with the mobile terminal using the same frequency band, the transmitting of the first control information may include transmitting the first control information through transposing a location of the transmission frame and the reception frame in the TDD frame signal, and the receiving the second control information may include receiving the second control information through transposing the location of the transmission frame and reception frame in the TDD frame signal.

The transmitting of the first control information may include transmitting the first control information through shifting a location of the transmission frame and reception frame in the TDD frame signal based on a predetermined value, and the receiving of the second control information may include receiving the second control information through shifting the location of the transmission frame and reception frame in the TDD frame signal based on the predetermined value.

The master base station and the femtocell base station apparatus may perform data communication with the mobile terminal using different frequency bands from each other, the transmitting of the first control information may include transmitting the first control information using a first frequency band in a frequency band used for data communication with the mobile terminal or a third frequency band excluding the frequency band used for the data communication with the mobile terminal, and the receiving of the second control information may include receiving the second control information using the first frequency band in the frequency band used for data communication with the mobile terminal or the third frequency band excluding the frequency band used for the data communication with the mobile terminal.

In another general aspect, a mobile terminal performs data communication with a master base station and a femtocell base station apparatus, the mobile terminal including a sensing unit configured to sense a wireless propagation environment around the femtocell base station apparatus to obtain wireless propagation environment information, and a transceiver configured to transmit the sensed wireless propagation environment information to the femtocell base station apparatus and to perform data communication with one of the master base station and the femtocell base station apparatus.

The femtocell base station apparatus may transmit first control information including the wireless propagation environment information to the master base station, and receive second control information corresponding to the first control information from the master base station, and the transceiver may perform data communication with one of the master base station and the femtocell base station apparatus based on the second control information.

The second control information may include at least one of a frequency band available to the femtocell base station apparatus, maximum transmission power permitted in the frequency band, and cell coverage of the femtocell base station apparatus.

Other features and aspects will become apparent from the following detailed description, the drawings, and the claims.

### BRIEF DESCRIPTION OF THE DRAWINGS

FIGS. 1A and 1B are conceptual diagrams illustrating exemplary control information transmission/reception performed between a master base station and a femtocell base station apparatus.

FIG. 2 is a block diagram of an exemplary configuration of a femtocell base station apparatus and a master base station.

FIGS. 3 and 4 are block diagrams of an exemplary configuration of a TDD data frame used when communication is performed between a femtocell base station apparatus, a master base station, and a mobile terminal.

FIG. 5 is a flowchart of an exemplary procedure for controlling a femtocell base station apparatus.

FIG. 6 is a block diagram of an exemplary configuration of a mobile terminal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, descriptions of well-known functions and constructions may be omitted for increased clarity and conciseness.

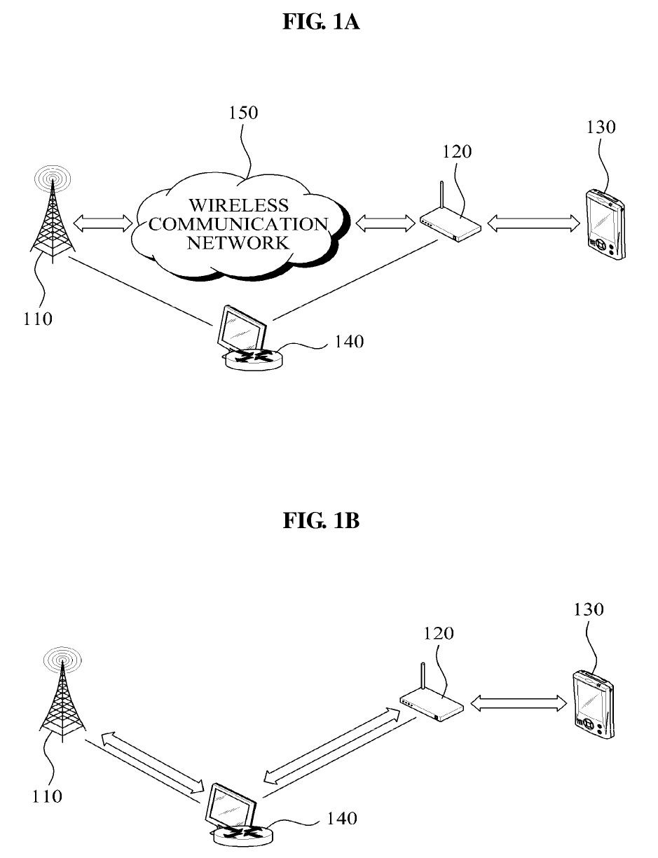

FIGS. 1A and 1B are conceptual diagrams illustrating exemplary control information transmission/reception performed between a master base station and a femtocell base station apparatus.

Hereinafter, the control information transmission/reception performed between the master base station and the femtocell base station apparatus is described with reference to FIGS. 1A and 1B.

FIG. 1A illustrates that the master base station 110 and the femtocell base station apparatus 120 perform transmission/reception of control information using a wireless communication network 150.

Data transmitted/received between the mobile terminal 130 and the master base station 110 or between the mobile terminal 130 and the femtocell base station apparatus 120 is transmitted/received using a wired network (e.g., the Internet) through a wired network server 140, and control information between the master base station 110 and the femtocell base station apparatus 120 is transmitted/received through a wireless network 150. The control information may include first control information that the femtocell base station apparatus 120 transmits to the master base station 110 and second control information that the master base station 110 transmits to the femtocell base station apparatus 120.

The above-described transmission/reception of the control information may be performed during an initialization process of the femtocell base station apparatus 120. Also, the control information transmission/reception may be performed periodically or aperiodically.

In some implementations, the femtocell base station apparatus 120 senses a wireless propagation environment around the femtocell base station apparatus 120 and transmits first control information including wireless propagation environment information to the master base station 110.

Also, the femtocell base station apparatus 120 may generate first control information including various information required when data communication is performed with the mobile terminal 130, in addition to wireless propagation environment information, and transmit to the master base station 110. For example, the required information includes at least one from among a frequency bandwidth used for data communication, a minimal cell coverage of the femtocell base station apparatus 120, and open/closed access.

Also, in some implementations, before transmitting the first control information, the femtocell base station apparatus 120 is uplink-synchronized and downlink-synchronized with the master base station 110. When the femtocell base station apparatus 120 and the master base station 110 are synchronized, the femtocell base station apparatus 120 may also be synchronized with another femtocell base station apparatus (not illustrated) adjacent to the femtocell base station apparatus 120 and controlled by the master base station 110.

When receiving the first control information from the femtocell base station apparatus 120, the master base station 110 may transmit second control information for controlling data communication between the femtocell base station apparatus 120 and the mobile terminal 130 to the femtocell base station apparatus 120 based on the first control information.

In some implementations, the second control information includes at least one frequency from among a frequency band available to the femtocell base station apparatus 120 and maximum transmission power permitted in the frequency band. That is, the frequency band in which the femtocell base station 120 performs data communication, a permitted maximum transmission power, and a cell coverage that the femtocell base station apparatus 120 manages may be determined by the master base station 110.

The permitted maximum transmission power may be either a maximum transmission power permitted with respect to an entire frequency band available to the femtocell base station apparatus 120 or a maximum transmission power permitted for each sub-band in the frequency band available to the femtocell base station apparatus 120.

Also, the second control information may include wireless propagation environment information around at least one femtocell base station apparatus (not illustrated) adjacent to the femtocell base station apparatus 120. In this instance, the femtocell base station apparatus 120 may determine a frequency band and a permitted maximum transmission power used for data communication based on the second control information of itself.

When receiving the second control information from the master base station 110, the femtocell base station apparatus 120 performs data communication (femtocell service) with the mobile terminal 130 based on the second control information.

FIG. 1B illustrates that the master base station 110 and the femtocell base station apparatus 120 perform transmission/reception of control information using a wired network server 140.

That is, the master base station 110 and the femtocell base station apparatus 120 may perform transmission/reception of the first control information and second control information using a wired communication network (e.g., the Internet) through the wired network server 140.

Also, although not illustrated in FIGS. 1A and 1B, the master base station 110 and the femtocell base station apparatus 120 may transmit/receive a portion of control information using the wired communication network through the wired network server 140 and may transmit/receive the other portion of the control information using the wireless communication network 150.

Also, although FIGS. 1A and 1B illustrate that the femtocell base station apparatus 120 transmits/receives the control information with the single master base station 110, the femtocell base station apparatus may transmit/receive the control information with a plurality of master base stations.

As described above, the femtocell base station apparatus 120 and the master base station 110 transmit/receive the control information, and thus, the frequency band and permitted maximum transmission power used for data communication between the femtocell base station apparatus 120 and the mobile terminal 130 may be controlled to be appropriate for the wireless propagation communication environment varying in real time around the femtocell base station apparatus 120. Accordingly, spectrum interference between a single femtocell base station apparatus and adjacent femtocell base station apparatus and spectrum interference between the femtocell base station apparatus and the master base station may be reduced or eliminated.

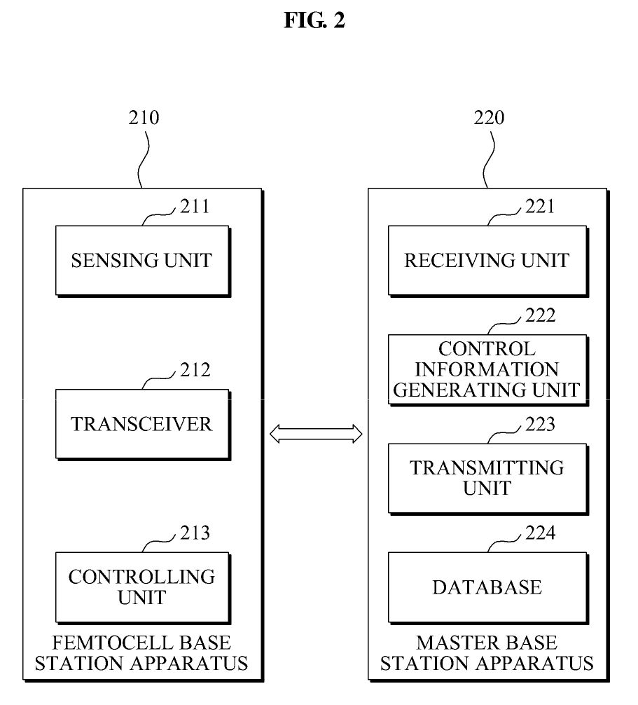

FIG. 2 is a block diagram illustrating an exemplary configuration of a femtocell base station apparatus and a master base station.

The femtocell base station apparatus 210 includes a sensing unit 211, a transceiver 212, and a controlling unit 213, and the master base station 220 includes a receiving unit 221, a control information generating unit 222, and a transmitting unit 223. The master base station 220 may further include a database 224. Hereinafter, the femtocell base station apparatus 210 and master base station 220 are described in detail with reference to FIG. 2.

As described above, the femtocell base station apparatus 210 and the master base station 220 transmit/receive control information.

The sensing unit 211 of the femtocell base station apparatus 210 senses a wireless propagation environment around the femtocell base station 210 to obtain wireless propagation environment information. That is, the sensing unit 211 performs sensing of a surrounding wireless propagation environment used for data communication with a mobile terminal in a cell coverage managed by the femtocell base station apparatus 210.

In some implementations, the wireless propagation environment information includes at least one of a channel gain of at least one frequency band and signal-to-noise ratio (SNR) with respect to the at least one frequency band. Whether an adjacent femtocell base station apparatus exists, channel condition in an available frequency band, and the like may be inferred from the channel gain and the SNR.

The transceiver 212 of the femtocell base station apparatus 210 transmits first control information including the wireless propagation environment information to at least one adjacent master base station apparatus, and receives second control information from the at least one master base station.

That is, a number of master base stations 220 that perform transmission/reception of the control information with the femtocell base station apparatus 210 may be plural.

The transceiver 212 may transmit the first control information and receive the second control information via at least one of a wired communication network and a wireless communication network.

The first control information may further include at least one of a frequency bandwidth required for data communication between the femtocell base station apparatus 210 and a mobile terminal (not illustrated), an amount of data to be communicated, and a minimal cell coverage of the femtocell base station apparatus 210. Also, the wireless propagation environment information may further include information for an amount of spectrum interference in the surrounding wireless propagation environment.

That is, the transceiver 212 may transmit the first control information further including information required for data communication with a mobile terminal (not illustrated) to the master base station 220. As described below, the first control information may be used as references when the master base station 220 generates the second control information.

The receiving unit 221 of the master base station 220 receives the first control information transmitted from the transceiver 212 of the femtocell base station 210. That is, the receiving unit 221 receives the first control information including the wireless propagation environment information around the femtocell base station apparatus from the femtocell base station apparatus. As an example, the receiving unit 221 may receive the first control information from at least one femtocell base station apparatus 210.

The control information generating unit 222 of the master base station 220 may generate the second control information that controls an operation of the femtocell base station apparatus 210 based on the received first control information.

The control unit 213 of the femtocell base station apparatus 210 controls data communication performed between the transceiver 212 and a mobile terminal (not illustrated).

That is, the femtocell base station apparatus 210 may perform communication with the master base station and with the mobile terminal (not illustrated) using a single transceiver 212, and the controlling unit 213 controls data communication performed between the femtocell base station apparatus 210 and the mobile terminal (not illustrated).

As described above, when the transceiver 212 receives the second control information including at least information from among a frequency band available to the femtocell base station apparatus 210, a maximum transmission power permitted in the frequency band, and a cell coverage of the femtocell base station apparatus 210, the controlling unit 213 controls the data communication with the mobile terminal (not illustrated) based on the information.

In some implementations, the second control information includes wireless propagation environment information around at least one femtocell base station apparatus (not illustrated) adjacent to the femtocell base station apparatus 210. In some implementations, the second control information includes at least one from among a frequency band available to the femtocell base station apparatus 210, maximum transmission power permitted in the frequency band, and a cell coverage of the femtocell base station apparatus.

That is, to control the operation of the femtocell base station apparatus 210, the control information generating unit 222 may determine cell parameters, such as the frequency band available to the femtocell base station apparatus 210, a permitted maximum transmission power, a cell coverage, and the like.

The master base station 220 may further include a database 224 storing at least one of the first control information and the second control information.

As described above, the transceiver 212 of the femtocell base station apparatus 210 transmits the first control information periodically or aperiodically, and receives the second control information. In this instance, when the master base station 220 receives the same first control information, a processing for generating second control information based on the same first control information is unnecessarily repeated. Accordingly, the control information generating unit 222 may compare the received first control information with first control information stored in the database 224, and if similar first control information is retrieved from the database 224, the control information generating unit 222 may extract relevant second control information.

The transmitting unit 223 of the master base station 220 transmits the second control information to the femtocell base station apparatus 210. The transceiver 212 of the femtocell base station apparatus 210 receives the second control information transmitted from the master base station 220. The controlling unit 213 of the femtocell base station apparatus 210 controls data communication performed between the transceiver 212 and a mobile terminal based on the received second control information.

In this instance, the controlling unit 213 may directly determine cell parameters required for data communication, such as an available frequency band, maximum transmission power permitted in the frequency band, a cell coverage of the femtocell base station apparatus 210, and the like. For example, the wireless propagation environment information around at least one femtocell base station apparatus (not illustrated) adjacent to the femtocell base station apparatus 210 may be extracted from the database 224 of the master base station 220.

Accordingly, spectrum interference between the femtocell base station apparatus 210 and femtocell base station apparatus adjacent thereto and spectrum interference between the femtocell base station apparatus 210 and the master base station 220 may be reduced or eliminated.

In some implementations, transmission/reception of control information between the femtocell base station apparatus 210 and the master base station 220 and data communication between the femtocell base station apparatus 210 and a mobile terminal (not illustrated) may be performed using a time division duplex (TDD) method. When communication is performed using the TDD method, a TDD frame signal including a transmission frame and reception frame is used. That is, the transceiver 212 of the femtocell base station apparatus 210 transmits the first control information, receives the second control information, and performs data communication with the mobile terminal using the TDD frame signal including the transmission frame and reception frame.

Also, the master base station 220 and the transceiver 212 may perform data communication with the mobile terminal (not illustrated) using the same frequency band, and the controlling unit 213 may transpose a location of the transmission frame and reception frame in the TDD frame signal to control the transceiver to transmit the first control information and receive the second control information.

Also, in some implementations, the master base station 220 and the transceiver 212 perform data communication with a mobile terminal (not illustrated) using the same frequency band, and the controlling unit 213 shift a location of the transmission frame and the reception frame in the TDD frame signal based on a predetermined value to control the transceiver 212 to transmit the first control information and receive the second control information.

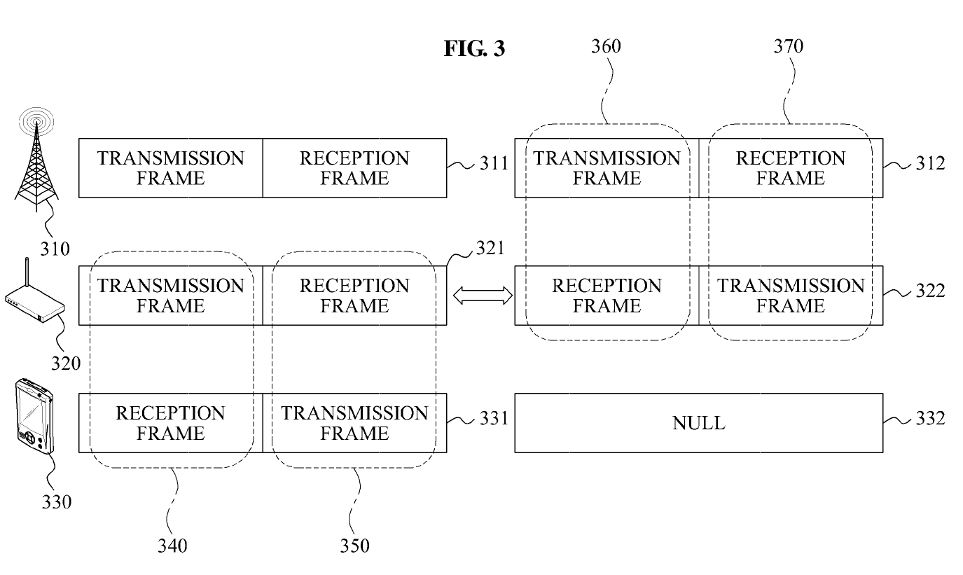

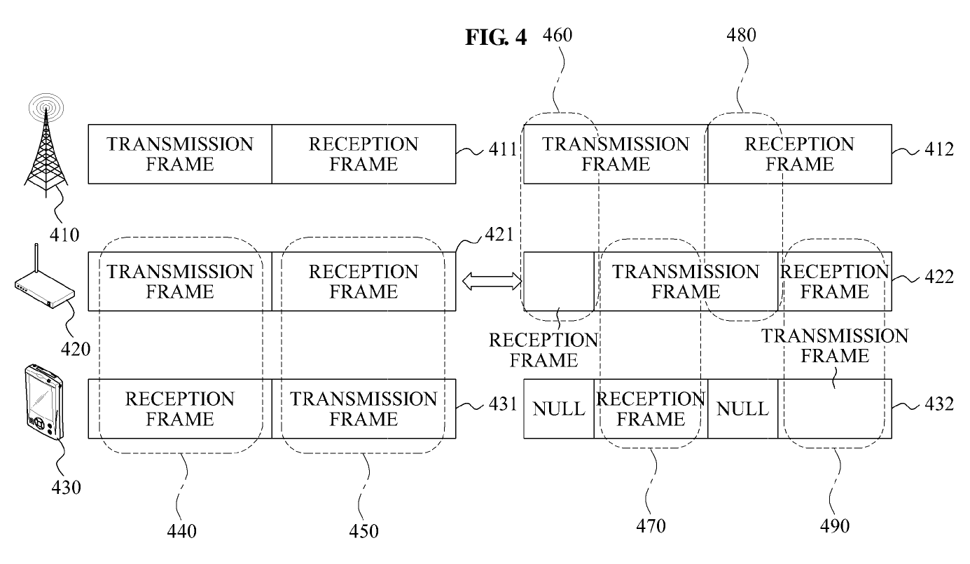

Hereinafter, communication performed between the femtocell base station apparatus 210, the master base station 220 and the mobile terminal (not illustrated) using the TDD method will be described in detail with reference to FIGS. 3 and 4.

FIGS. 3 and 4 illustrate an exemplary configuration of a TDD data frame used when communication is performed between a femtocell base station apparatus, a master base station, and a mobile terminal.

FIG. 3 illustrates an exemplary configuration of transposing locations of sub frames in the TDD data frame. The master base station 310 performs communication using a data frame 311 and a data frame 312, the femtocell base station apparatus 320 performs communication using a data frame 321 and a data frame 322, and the mobile terminal 330 performs communication using a data frame 331 and a data frame 332. The data frame 311, the data frame 321, and the data frame 331 are data frames used when data communication between the femtocell base station apparatus 320 and the mobile terminal 330 is performed.

As shown in FIG. 3, a transmission frame of the data frame 321 and a reception frame of the data frame 331 are used in a first time 340, a reception frame of the data frame 321 and a transmission frame of the data frame 331 are used in a second time 350, and thus, data communication between the femtocell base station apparatus 320 and mobile terminal 330 is possible.

Next, the data frame 312, the data frame 322, and the data frame 332 are data frames used when control information is transmitted/received between the femtocell base station apparatus 320 and the master base station 310. When transmission/reception of control information is necessary, the femtocell base station apparatus 320 modifies a frame structure of the data frame 321 to be similar to the data frame 322. That is, the femtocell base station apparatus 320 transposes (switches) a location of the transmission frame and reception frame in the data frame 321.

When the femtocell base station apparatus 320 modifies the frame structure of the data frame 321 to be similar to the data frame 322, a reception frame of the data frame 322 and a transmission frame of the data frame 312 are used in a third time 360, and a transmission frame of the data frame 322 and a reception frame of the data frame 312 are used in fourth time 370, and thus, transmission/reception of control information between the femtocell base station apparatus 320 and master base station 310 is possible. In this instance, since the data frame 322 is NULL, data communication between the mobile terminal 330 and master base station 310 or data communication between the mobile terminal 330 and the femtocell base station apparatus 320 are not performed.

As described above, transmission/reception of the control information is performed in an initialization process of the femtocell base station apparatus 320, and performed periodically or aperiodically, and thus, the TDD data frame structure is also changed when the femtocell base station apparatus 320 is initialized and changed periodically or aperiodically.

Considering that a length of a TDD data frame is short and a number of the mobile terminals 330 in a cell coverage of the femtocell base station apparatus 320 is small, even though data communication between the femtocell base station apparatus 320 and the mobile terminal 330 is temporarily disconnected, the temporary disconnection may not affect Quality of Service (QoS) of the mobile terminal.

Also, the femtocell base station apparatus 320 may communication with both the master base station 310 and the mobile terminal 330 through changing the TDD data frame structure, and thus, the master base station 310 and the femtocell base station apparatus 320 may not need an additional RF chain for transmitting/receiving the control information.

When the data frame 321 may need to be changed to the data frame 322, the femtocell base station apparatus 320 may report the above to the mobile terminal 330 in advance.

FIG. 4 illustrates an exemplary configuration of shifting locations of sub frames in the TDD data frame based on a predetermined value.

In the same manner as the description of FIG. 3, the master base station 410 performs communication using a data frame 411 and a data frame 412, the femtocell base station apparatus 420 performs communication using a data frame 421 and a data frame 422, and a mobile terminal 430 performs communication using a data frame 431 and a data frame 432, respectively.

The data frame 411, the data frame 421, and the data frame 431 are data frames used when data communication between the femtocell base station apparatus 420 and the mobile terminal 430 is performed.

In the same manner as the description of FIG. 3, a transmission frame of the data frame 421 and a reception frame of the data frame 431 are used in a first time 440, a reception frame of the data frame 421 and a transmission frame of the data frame 431 are used in a second time 450, and thus, data communication between the femtocell base station apparatus 420 and mobile terminal 430 is possible.

Next, the data frame 412, data frame 422, and data frame 432 are data frames used when control information is transmitted/received between the femtocell base station apparatus 420 and the master base station 430.

That is, in the same manner as the description of FIG. 3, control information is transmitted and/or received; the femtocell base station apparatus 420 modifies a frame structure of the data frame 421 to be similar to the data frame 422. However, in this instance, unlike the description of FIG. 3, the femtocell base station apparatus 420 shifts a location of the transmission frame and reception frame in the data frame 421 based on a predetermined value.

Referring to FIG. 4, a reception frame of the data frame 422 and a transmission frame of the data frame 412 are used in a third time 460, and a transmission frame of the data frame 422 and a reception frame of the data frame 412 are used in fifth time 480, and thus, transmission/reception of control information between the femtocell base station apparatus 420 and master base station 410 is possible. Also, a transmission frame of the data frame 422 and a reception frame of the data frame 432 are used in a fourth time 470, and a reception frame of the data frame 422 and a transmission frame of the data frame 432 are used in sixth time 490, and thus, data communication between the femtocell base station apparatus 420 and mobile terminal 430 is possible. In this instance, since the data frame 432 corresponding to the third time 460 and fifth time 480 is NULL, data communication between the mobile terminal 430 and master base station 410 or data communication between the mobile terminal 430 and the femtocell base station apparatus 420 are not performed.

Also, the TDD data frame structure is changed when the femtocell base station apparatus 420 is initialized and changed periodically or aperiodically. Also, the femtocell base station apparatus 420 may not need an additional RF chain for transmitting/receiving the control information with the master base station 410. Also, when the data frame 421 may need to be changed to the data frame 422, the femtocell base station apparatus 420 may report the above to the mobile terminal 430 in advance.

Referring again to FIG. 2, the femtocell base station apparatus 210 and the master base station 220 will be described.

In some implementations, the master base station 220 and the transceiver 212 perform data communication with a mobile terminal (not illustrated) using different frequency bands from each other, and the transceiver 212 transmits the first control information and receives the second control information using a first frequency band in a frequency band used for data communication with the mobile terminal or a third frequency band excluding the frequency bands used for the data communication with the mobile terminal.

That is, the femtocell base station apparatus 210 may perform data communication with the mobile terminal (not illustrated) using a second frequency band having a frequency band different from a frequency band in which the master base station 220 provides cellular service. In this instance, the transceiver 212 may transmit/receive control information using the first frequency band, which is a portion of the second frequency band. Also, the femtocell base station apparatus 210 may transmit the first control information and receive the second control information using the third frequency band, which is a different frequency band from the second frequency band.

When the control information is transmitted/received using the first frequency band, the master base station 220 may need an additional RF chain for communicating with the transceiver 212. However, since the first frequency band is included in the second frequency band, the femtocell base station apparatus 210 may not need additional RF chain for transmitting/receiving the control information with the master base station 220.

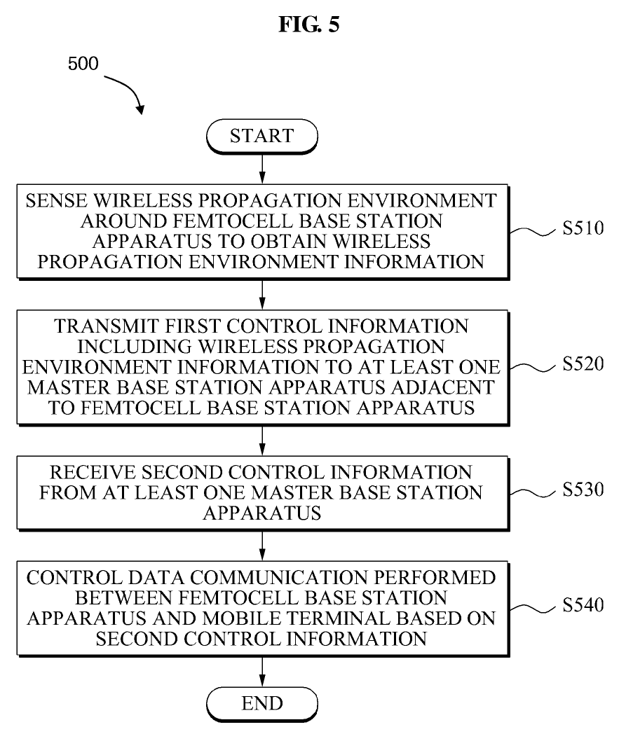

FIG. 5 is a flowchart of an exemplary procedure 500 for controlling a femtocell base station apparatus. Hereinafter, the method for controlling the femtocell base station apparatus will be described with reference to FIG. 5. The femtocell base station apparatus may be of, for example, FIG. 2.

First, a wireless propagation environment around the femtocell base station apparatus is sensed and wireless propagation environment information is obtained in operation S510. As an example, the wireless propagation environment information may be a channel gain of a frequency band, SNR with respect to the frequency band, and the like, which may be used for inferring whether an adjacent femtocell base station apparatus exists, a channel condition of an available frequency band, and the like.

In operation S520, first control information including the wireless propagation environment information is transmitted to at least one master base station adjacent to the femtocell base station apparatus, and in operation S530, second control information is received from the at least one master base station.

The femtocell base station apparatus and the master base station transmit and/or receive the first control information and second control information for controlling an operation of the femtocell base station apparatus, thereby controlling the operation of the femtocell base station apparatus to be appropriate for each case.

In some implementations, in operations S520 and S530, the first control information is transmitted and the second control information is received via at least one of a wired communication network or wireless communication network. That is, the first control information and the second control information may be transmitted and/or received via the wired communication network and transmitted/received via the wireless communication network. Also, a portion of the first control information and the second control information may be transmitted and/or received via the wired network communication network and the other portion may be transmitted and/or received via the wireless communication network.

In operation S540, data communication performed between the femtocell base station apparatus and a mobile terminal is controlled based on the second control information.

According to an example embodiment, transmission and/or reception of control information between the femtocell base station apparatus and the master base station may be performed using a TDD method. That is, the first control information is transmitted to the master base station using a TDD frame signal including a transmission frame and a reception frame in operation S520. Also, the second control information is received from the master base station using the TDD frame signal including the transmission frame and the reception frame in operation S530.

In some implementations, the master base station and the femtocell base station apparatus performs data communication with the mobile terminal using the same frequency band, and in operations S520 and S530, the master base station and the femtocell base station apparatus transpose a location of the transmission frame and reception frame in the TDD frame signal, thereby transmitting the first control information and receiving the second control information.

Also, in some implementations, the master base station and the femtocell base station apparatus perform data communication with the mobile terminal using the same frequency band, and in operation S520 and S530, the master base station and the femtocell base station apparatus shift the location of the transmission frame and reception frame in the TDD frame signal based on a predetermined value, thereby transmitting the first control information and receiving the second control information.

Also, the master base station and the femtocell base station apparatus may perform data communication with the mobile terminal using different frequency bands from each other, and in operations S520 and S530, the master base station and the femtocell base station apparatus may transmit the first control information and receive the second control information using a first frequency band in a frequency band used for data communication with the mobile terminal or a third frequency band excluding the frequency bands used for the data communication with the mobile terminal.

Examples of controlling methods of a femtocell base station apparatus have been described, and the configuration with respect to the femtocell base station apparatus as described with reference to FIG. 2 is applicable to other implementations. Accordingly, a more detailed description will be omitted.

The methods described above and hereinafter, including the exemplary methods for controlling a femtocell base station apparatus, may be recorded in computer-readable storage media including program instructions to implement various operations embodied by a computer. The storage media may include, alone or in combination with the program instructions, data files, data structures, and the like. The storage media and program instructions may be those specially designed and constructed for the purposes of example embodiments, or they may be of the kind well-known and available to those having skill in the computer software arts. Examples of computer-readable storage media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of example embodiments, and vice versa. In addition, a computer-readable storage medium may be distributed among computer systems connected through a network and computer-readable codes or program instructions may be stored and executed in a decentralized manner.

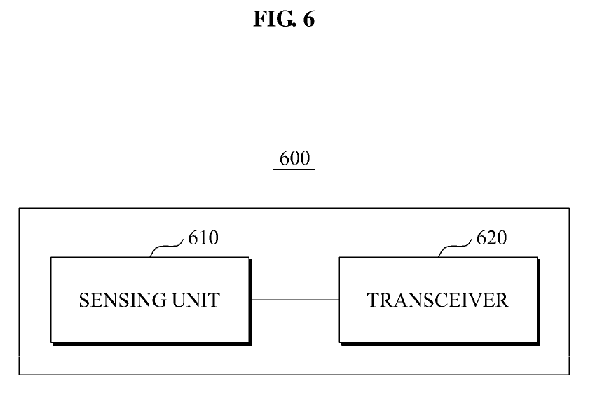

FIG. 6 is a block diagram illustrating an exemplary configuration of a mobile terminal 600. The exemplary mobile terminal 600 will be described in detail with reference to FIG. 6. The mobile terminal 600 performs data communication with a master base station and a femtocell base station apparatus. The mobile terminal 600 includes a sensing unit 610 and a transceiver 620. The sensing unit 610 senses a wireless propagation environment around the femtocell base station to obtain wireless propagation environment information.

That is, as described in FIG. 2, the wireless propagation environment around the femtocell base station apparatus may be sensed by the femtocell base station apparatus 210, and also may be sensed by the mobile terminal 600.

The wireless propagation environment information may include at least one of a channel gain of at least one frequency band and an SNR with respect to the at least one frequency band.

The transceiver 620 transmits the sensed wireless propagation environment information to the femtocell base station apparatus, and also performs data communication with one of the master base station and the femtocell base station apparatus.

In some implementations, the femtocell base station transmits first control information including the wireless propagation environment information to the master base station, and receives second control information corresponding to the first control information. In this case, the transceiver 620 may perform data communication with one of the master base station and the femtocell base station apparatus. The second control information may include at least one of a frequency band available to the femtocell base station apparatus, maximum transmission power permitted in the frequency band, and cell coverage of the femtocell base station apparatus.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A femtocell base station apparatus, comprising:
a sensing unit configured to sense a wireless propagation environment around the femtocell base station apparatus to obtain wireless propagation environment information;
a transceiver configured to transmit first control information including the wireless propagation environment information to at least one master base station adjacent to the femtocell base station apparatus, and to receive second control information from the at least one master base station; and
a controlling unit configured to control data communication performed between the transceiver and a mobile terminal based on the second control information.

2. The apparatus of claim 1, wherein the transceiver transmits the first control information and receives the second control information using at least one of a wired communication network and a wireless communication network.

3. The apparatus of claim 1, wherein the wireless propagation environment information includes at least one of a channel gain of at least one frequency band and a signal-to-noise ratio (SNR) with respect to the at least one frequency band.

4. The apparatus of claim 1, wherein the first control information further includes at least one of a frequency bandwidth used when the data communication is performed, an amount of data to be communicated during the data communication, and a minimum cell coverage of the femtocell base station apparatus.

5. The apparatus of claim 1, wherein the second control information includes at least one of a frequency band available to the femtocell base station apparatus, maximum transmission power permitted in the frequency band, and a cell coverage of the femtocell base station apparatus.

6. The apparatus of claim 1, wherein the second control information includes wireless propagation environment information around at least one femtocell base station apparatus adjacent to the femtocell base station apparatus.

7. The apparatus of claim 1, wherein the transceiver transmits the first control information using a time division duplex (TDD) frame signal including a transmission frame and reception frame, receives the second control information, and performs data communication with the mobile terminal.

8. The apparatus of claim 7, wherein the master base station and the transceiver perform data communication with the mobile terminal using the same frequency band, and the controlling unit transposes a location of the transmission frame and reception frame in the TDD frame signal to control the transceiver to transmit the first control information and receive the second control information.

9. The apparatus of claim 7, wherein the master base station and the transceiver perform data communication with the mobile terminal using the same frequency band, and the controlling unit shifts a location of the transmission frame and reception frame in the TDD frame signal based on a predetermined value to control the transceiver to transmit the first control information and receive the second control information.

10. The apparatus of claim 1, wherein the master base station and the transceiver perform data communication with the mobile terminal using different frequency bands from each other, and the transceiver transmits the first control information and receives the second control information using a first frequency band in a frequency band used for data communication with the mobile terminal or a third frequency band excluding the frequency bands used for the data communication with the mobile terminal.

11. A master base station controlling a femtocell base station apparatus, the master base station comprising:
a receiving unit configured to receive first control information including wireless propagation environment information around the femtocell base station apparatus from the femtocell base station apparatus;
a control information generating unit configured to generate second control information controlling an operation of the femtocell base station apparatus based on the first control information; and
a transmitting unit configured to transmit the second control information to the femtocell base station apparatus.

12. The apparatus of claim 11, further comprising:
a database storing at least one of the first control information and the second control information.

13. The apparatus of claim 11, wherein the second control information includes at least one of a frequency band available to the femtocell base station apparatus and maximum transmission power permitted in the frequency band.

14. A method for controlling a femtocell base station apparatus, the method comprising:
sensing a wireless propagation environment around the femtocell base station apparatus to obtain wireless propagation environment information;
transmitting first control information including the wireless propagation environment information to at least one master base station adjacent to the femtocell base station apparatus;
receiving second control information from the at least one master base station; and
controlling data communication performed between the femtocell base station apparatus and a mobile terminal based on the second control information.

15. The method of claim 14, wherein the transmitting of the first control information includes transmitting the first control information via at least one of a wired communication network and a wireless communication network, and
the receiving of the second control information includes receiving the second control information via at least one of the wired communication network and the wireless communication network.

16. The method of claim 14, wherein the transmitting of the first control information includes transmitting the first control information using a Time Division Duplex (TDD) frame signal including a transmission frame and a reception frame, and
the transmitting of the second control information includes transmitting the second control information using the TDD frame signal including the transmission frame and the reception frame.

17. The method of claim 16, wherein the master base station and the femtocell base station perform data communication with the mobile terminal using the same frequency band,
the transmitting of the first control information includes transmitting the first control information through transposing a location of the transmission frame and the reception frame in the TDD frame signal, and
the receiving of the second control information includes receiving the second control information through transposing the location of the transmission frame and reception frame in the TDD frame signal.

18. The method of claim 16, wherein the transmitting of the first control information includes transmitting the first control information through shifting a location of the transmission frame and reception frame in the TDD frame signal based on a predetermined value, and
the receiving of the second control information includes receiving the second control information through shifting the location of the transmission frame and reception frame in the TDD frame signal based on the predetermined value.

19. The method of claim 14, wherein the master base station and the femtocell base station apparatus perform data communication with the mobile terminal using different frequency bands from each other,
the transmitting of the first control information includes transmitting the first control information using a first frequency band in a frequency band used for data communication with the mobile terminal or a third frequency band excluding the frequency band used for the data communication with the mobile terminal, and
the receiving of the second control information includes receiving the second control information using the first frequency band in the frequency band used for data communication with the mobile terminal or the third frequency band excluding the frequency band used for the data communication with the mobile terminal.

20. A computer readable storage medium comprising computer readable instructions causing a computer to implement the method of claim 14.

21. A mobile terminal performing data communication with a master base station and a femtocell base station apparatus, the mobile terminal comprising:
a sensing unit configured to sense a wireless propagation environment around the femtocell base station apparatus to obtain wireless propagation environment information; and
a transceiver configured to transmit the sensed wireless propagation environment information to the femtocell base station apparatus, and to perform data communication with one of the master base station and the femtocell base station apparatus,
wherein the femtocell base station apparatus transmits first control information including the wireless propagation environment information to the master base station, and receives second control information corresponding to the first control information from the master base station, and the transceiver performs data communication with one of the master base station and the femtocell base station apparatus based on the second control information.

22. The mobile terminal of claim 21, wherein the second control information includes at least one of a frequency band available to the femtocell base station apparatus, maximum transmission power permitted in the frequency band, and cell coverage of the femtocell base station apparatus.
